(19) United States
(12) Patent Application Publication
(10) Pub. No.: US 2011/0191416 A1
(43) Pub. Date: Aug. 4, 2011

(54) Content Author Badges

(75) Inventors: David Glazer, Woodside, CA (US); Reza Behforooz, Menlo Park, CA (US); Bradley J. Fitzpatrick, San Francisco, CA (US)

(73) Assignee: Google, Inc., Mountain View, CA (US)

(21) Appl. No.: 12/767,741

(22) Filed: Apr. 26, 2010

Related U.S. Application Data
(60) Provisional application No. 61/300,410, filed on Feb. 1, 2010.

(51) Int. Cl. G06F 21/00; G06F 15/16; G06F 3/048

(52) U.S. Cl. 709/204; 726/28; 715/862

(57) ABSTRACT

A method executes at a server to: receive a request from a user at a client computer to establish authorship of content posted online by the user, wherein the content is stored at a host computer; and verify the identity of the user by verifying credentials of the user. After verifying the identity of the user, the method creates an author badge for the content, wherein the author badge includes a badge identifier; transmits the author badge to the client computer or the host computer, for affixing the author badge to the content at the host computer; stores at the server, location information identifying the online location of the content; and stores at the server, the badge identifier and verification information sufficient to verify that the content at the identified online location matches the content for which the author badge was created.

### RELATED APPLICATIONS

This application claims priority to U.S. Provisional Application Ser. No. 61/300,410, filed Feb. 1, 2010, entitled “Content Author Badges,” which is incorporated herein by reference in its entirety.

### TECHNICAL FIELD

The disclosed embodiments relate generally to online document content, and more specifically to methods to verify the authorship of content posted online.

### BACKGROUND

Individuals create online content in discussion forums, bulletin boards, web logs (“blogs”), and other websites. In some cases the posting of content is anonymous, but in other cases there is a name or ID associated with the content. One problem is that the name associated with content is generally unverified. That is, a user could create online content and associate an incorrect name with that content. For a reader of the content, this can create a problem, because the reader may rely on the reputation of the alleged author. An incorrect identification of authorship can also impugn or demean the reputation of the alleged author.

One partial solution to this problem is for a website to create user ID's and use those user ID's for all postings. For example, a user with a Yahoo!® ID uses that ID for many activities on the Yahoo!® website. With this partial solution, a viewer of online content can reliably assume that two or more postings associated with the same ID were written by the same individual.

However, there are at least two problems with this approach. First, there may be no way to associate the ID with a person. Even if the ID appears to include an embedded name, such as johnsmith2317528, there is no assurance that the ID belongs to a person with that name, nor does the embedded name necessarily indicate which of the many people with that name (e.g., “John Smith”) is the owner of the ID. More importantly, the ID's are useful only within the one website (or with a collection of websites), and they must be maintained by that website.

A second partial solution is a “universal” login that can be used by all websites. The Dot Net Passport created by Microsoft® is one implementation of this idea. This approach has a different set of problems. First, website administrators must choose to work with the “universal” login scheme. This creates additional work for each website administrator, and exposes websites to security risks by granting access to websites based on authentication from a third party. In addition, a universal login mechanism is designed to authenticate a user to access a website, not validate authorship of content posted on a website. Even if a website implements a universal login scheme, there is no guarantee that a name associated with the content is correct, or that the content does not become modified by another unauthorized user.

### SUMMARY

The above deficiencies and other problems associated with verifying authorship of content posted online are addressed by the present invention. The disclosed embodiments include methods and systems for an author of online content to establish authorship by acquiring a content author badge and affixing the content author badge to the content. Disclosed embodiments also include methods and systems that are invoked when a visitor views online content. Using a content author badge affixed to the online content, disclosed embodiments use previously stored verification data to verify the author and verify that the content has not been altered.

In accordance with some embodiments, a computer-implemented method executes at a server system with one or more processors and memory. The memory stores one or more programs for execution by the one or more processors, and the programs include instructions to: receive a request from a user at a client computer to establish authorship of content posted online by the user, wherein the content is stored at a host computer; and verify the identity of the user by verifying credentials of the user. The programs further include instructions that execute after verifying the identity of the user to: create an author badge for the content posted online by the user, wherein the author badge includes a badge identifier; transmit the author badge to the client computer or the host computer, for affixing the author badge to the content at the host computer; store at the server system, location information identifying an online location of the content posted online by the user; and store at the server system, the badge identifier and verification information sufficient to verify that the content at the identified online location matches the content for which the author badge was created.

In accordance with some embodiments, a computer-implemented method executes at a server computer system with one or more processors and memory. The memory stores one or more programs for execution by the one or more processors. The programs include instructions to receive from a client device, remotely located with respect to the server computer system, a request to verify a claim of authorship of content posted online at a hosting computer system. The hosting computer system is distinct from the server computer system. The request includes information identifying an online location of the content for which the claim of authorship is to be verified. The programs further include instructions that execute to: access previously stored authorship verification information, if any, corresponding to the online location identified by the request; compare the content at the identified online location with the previously stored authorship verification information, if any, to produce an authorship verification result; and return the authorship verification result to the client device.

In accordance with some embodiments, a computer-implemented method executes at a server computer system with one or more processors and memory. The memory stores one or more programs for execution by the one or more processors. The programs include instructions to: receive from a client device, remotely located with respect to the server computer system, a request for a listing of online content associated with an identified user; search a database for online content matching the request to produce a list of online content items; for each respective item in a plurality of the online content items in the list, perform an authorship verification to determine if the identified user can be verified as having authored (i.e., posted online) the respective item; and return to the client device information corresponding to at least a portion of the list of online content items. The returned information includes information identifying one or more of the content items for which the identified user has been verified as the author.

In accordance with some embodiments, a computer-implemented method executes at a server computer system with one or more processors and memory. The memory stores one or more programs for execution by the one or more processors. The programs include instructions to transmit to an author badge server a request to verify authorship of content posted online by a user. The request includes an online content location of the content posted online by the user. The programs further include instructions that execute to: transmit to the author badge server credentials of the user to verify the identity of the user; receive an author badge from the author badge server, wherein the author badge includes a badge identifier; and send a command together with the author badge to an online host corresponding to the content posted online by the user. The command instructs the online host to store the author badge on a web page at the online content location together with the content posted online by the user.

Thus methods and systems are provided that enable authors of online content to establish their authorship of the content, enable viewers of online content to verify the asserted authorship, and enable viewers to find online content by an identified author.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 illustrates an exemplary context in which some embodiments operate.

FIG. 2 is a block diagram of a host computer system according to some embodiments.

FIG. 3 is a block diagram of an author badge computer system according to some embodiments.

FIG. 4 is a block diagram of a client computer system according to some embodiments.

FIG. 5A depicts an exemplary verification data structure according to some embodiments.

FIG. 5B depicts an exemplary content author badge according to some embodiments.

FIGS. 6A and 6B provide a flowchart of a process for obtaining a content author badge and affixing the content author badge to the associated content according to some embodiments.

FIG. 7 provides a flowchart of a process for verifying authorship of online content using a content author badge associated with the online content according to some embodiments.

FIG. 8 provides a flowchart of a process, performed at a server, for finding online content associated with an identified author according to some embodiments.

FIG. 9 provides a flowchart of a process, performed at a client computer, for obtaining a content author badge and affixing the content author badge to the associated content according to some embodiments.

FIG. 10 schematically depicts an exemplary badging process according to some embodiments.

FIG. 11 schematically depicts an exemplary verification process according to some embodiments.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

### DESCRIPTION OF EMBODIMENTS

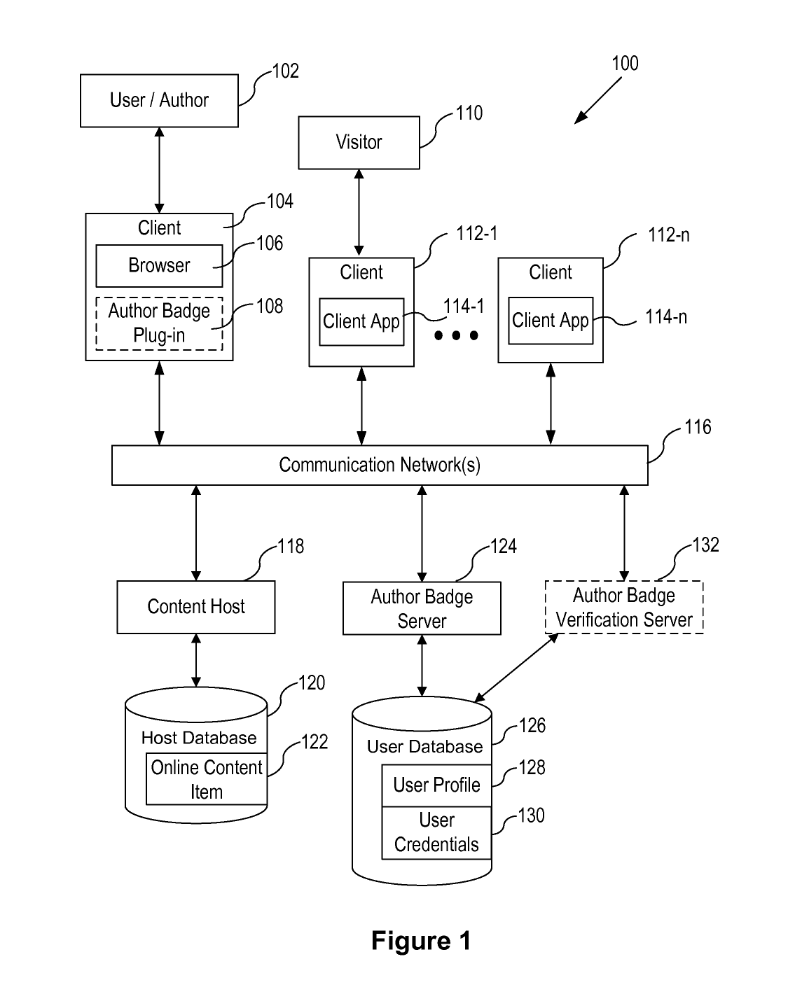

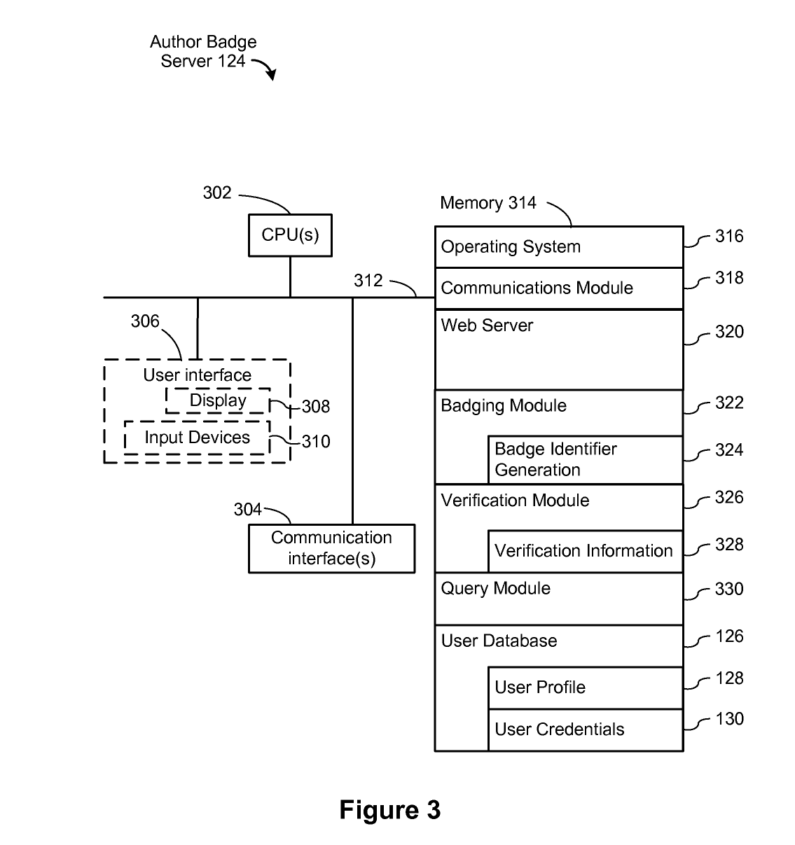

FIG. 1 is a block diagram of an embodiment of an author badge system 100. The system communicates over one or more networks 116 (such as the Internet). An author 102 of online content uses a client computer 104 running a web browser 106 or similar software program. The author communicates with an online host 118 to post one or more online content items 122. In some embodiments, the content items 122 are stored in a host database 120. In other embodiments, online content items are stored as files on a file server or other electronic storage device. If the author chooses to attach a byline to an online posting 122, the client computer 104 may communicate with an author badge server 124. In some embodiments, an author badge plug-in 108 runs within the browser 106 to communicate with the author badge server 124. In some embodiments, the author 102 initiates an explicit connection to the author badge server 124, but in other embodiments, the connection to the author badge server 124 is initiated automatically by the browser 106 or author badge plug-in 108. The author badge server 124 maintains, or has access to, a user database 126. In some embodiments, the user database 126 stores user profiles 128 and/or user credentials 130. In some embodiments, verification information 328 (FIG. 3) is stored in the user database 126. In other embodiments, verification information is stored in another database associated with an author badge verification server 132. If an author 102 is verified, the author badge server 124 provides a content author badge, which is subsequently affixed to an online content item 122 (i.e., an online content item 122 posted by the user) at the content host 118.

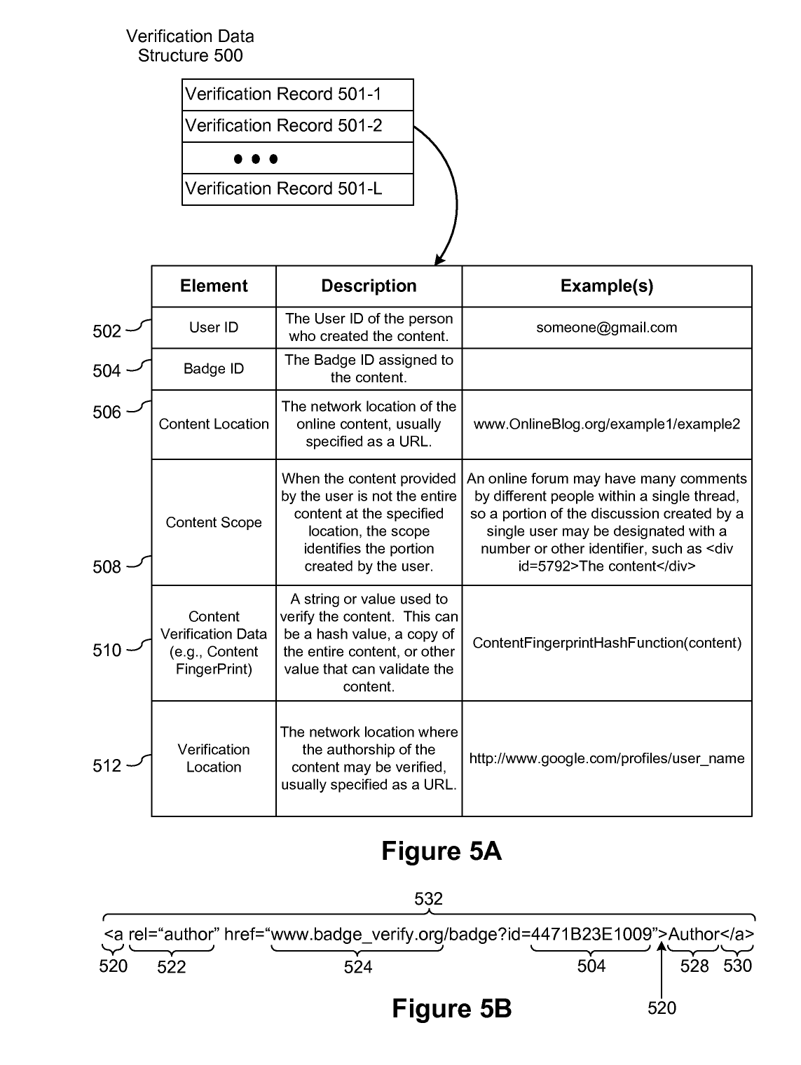

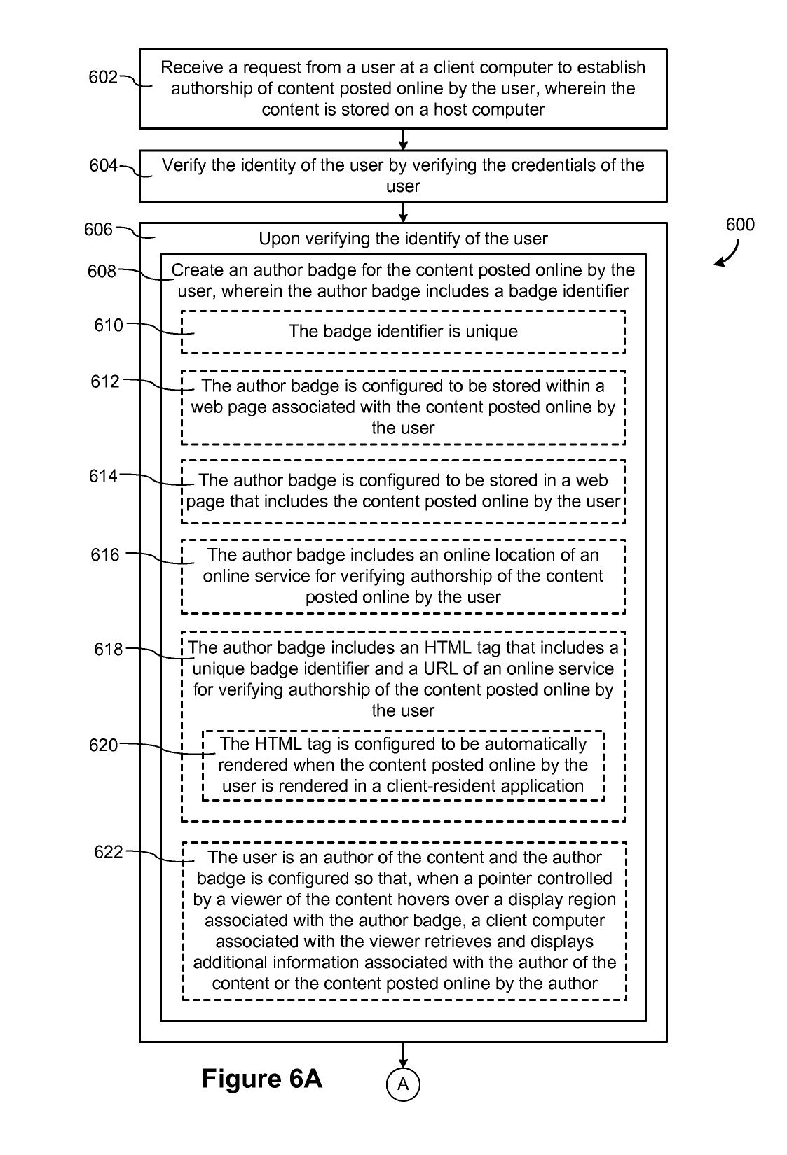

A visitor 110 may use a client computer 112-1 to view online content items 122 at a content host 118. Client computer 112-1 uses a client application such as a web browser 114-1 to communicate with a content host 118. Any number of client computers 112-1 to 112-n running client applications 114-1 to 114-n (such as web browsers) may communicate over the network 116 with a content host 118. In some embodiments, the visitor may choose to verify authorship of an online content item 122. In other embodiments, authorship of online content items 122 is automatically verified when a visitor views the online content item 122. To verify authorship of an online content item 122, client application 114-1 communicates over the network 116 with an author badge verification server 132. More details about the verification process are provided below with respect to FIGS. 5A, 5B, 7 and 11.

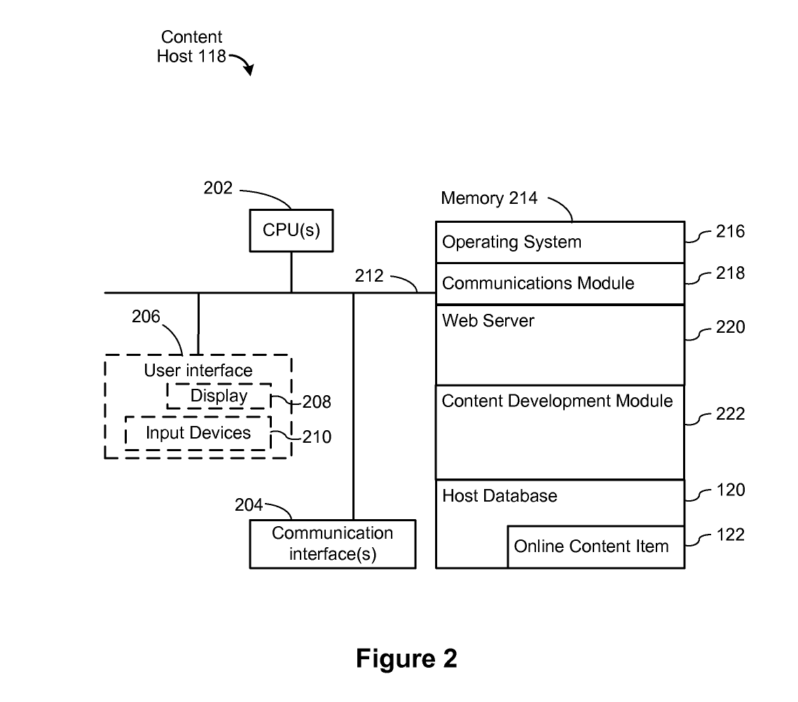

FIG. 2 is a block diagram illustrating a Content Host 118 that stores online content items 122 in accordance with some embodiments of the present invention. The Content Host 118 typically includes one or more processing units (CPU's) 202 for executing modules, programs and/or instructions stored in memory 214 and thereby performing processing operations; one or more network or other communications interfaces 204; memory 214; and one or more communication buses 212 for interconnecting these components. The communication buses 212 may include circuitry (sometimes called a chipset) that interconnects and controls communications between system components. In some embodiments, the Content Host 118 includes a user interface 206 comprising a display device 208 and one or more input devices 210. In some embodiments, memory 214 includes high-speed random access memory, such as DRAM, SRAM, DDR RAM or other random access solid state memory devices. In some embodiments, memory 214 includes non-volatile memory, such as one or more magnetic disk storage devices, optical disk storage devices, flash memory devices, or other non-volatile solid state storage devices. In some embodiments, memory 214 includes one or more storage devices remotely located from the CPU(s) 202. Memory 214, or alternately the non-volatile memory device(s) within memory 214, comprises a computer readable storage medium. In some embodiments, memory 214 or the computer readable storage medium of memory 214 stores the following programs, modules and data structures, or a subset thereof:
an operating system 216 that includes procedures for handling various basic system services and for performing hardware dependent tasks;
a communications module 218 that is used for connecting the Content Host 118 to other computers via the one or more communication network interfaces 204 (wired or wireless) and one or more communication networks 116, such as the Internet, other wide area networks, local area networks, metropolitan area networks, and so on;
a web server 220 that delivers appropriate web pages in response to requests from client computers;
a content development module 222 that allows users to create new online content. In some embodiments, the content development module 222 provides tools and features that facilitate creation of complex online content. In other embodiments, the content development module just provides a place to store content written or created by an author 102. In one example, the content development module 222 is a blog application that allows users to post content in blogs; and
a host database 120 that stores online content items 122. In some embodiments, the host database 120 is a SQL database, but in other embodiments, the host database is a file server that stores individual content items 122 as files. In some embodiments, two or more content items 122 are saved in a single file.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 214 may store a subset of the modules and data structures identified above. Furthermore, memory 214 may store additional modules or data structures not described above.

Although FIG. 2 shows a Content Host 118 used for storing and serving online content items, FIG. 2 is intended more as functional description of the various features which may be present in a set of one or more computers rather than as a structural schematic of the embodiments described herein. In practice, and as recognized by those of ordinary skill in the art, items shown separately could be combined and some items could be separated. For example, some items shown separately in FIG. 2 could be implemented on individual computer systems and single items could be implemented by one or more computer systems. The actual number of computers used to implement storing and serving of online content items, and how features are allocated among them will vary from one implementation to another, and may depend in part on the amount of data traffic that the system must handle during peak usage periods as well as during average usage periods.

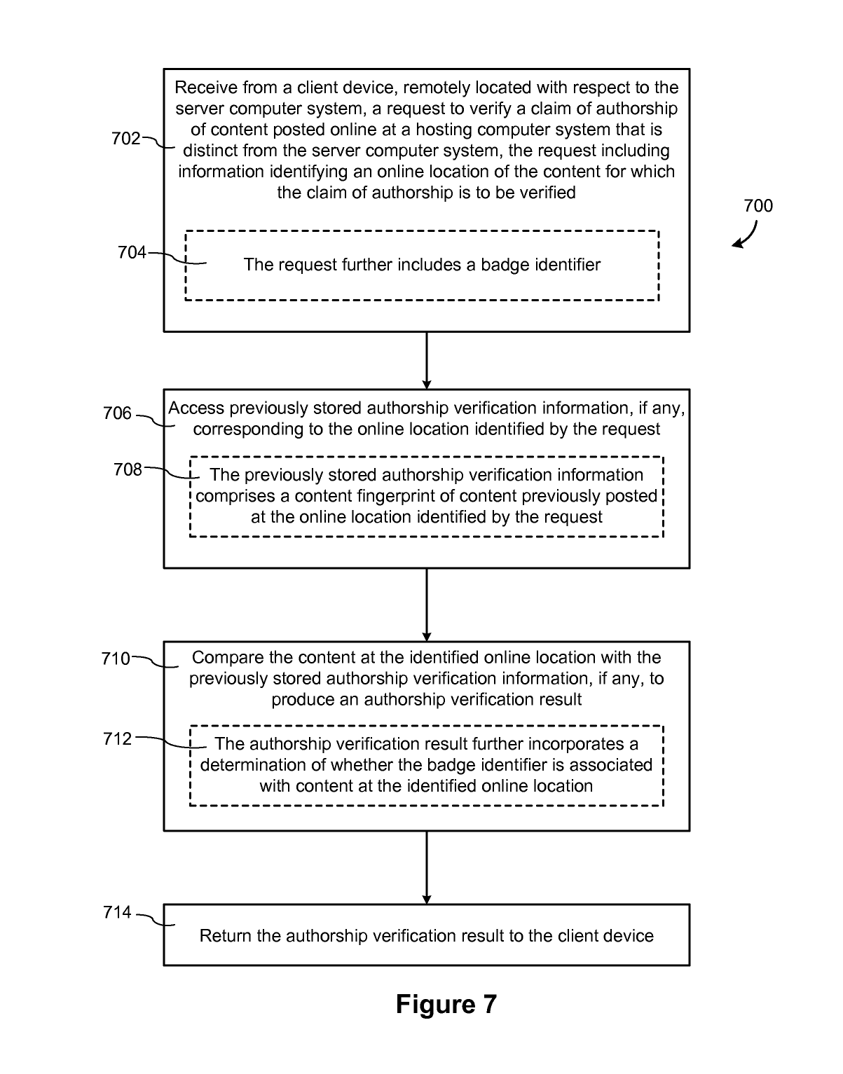

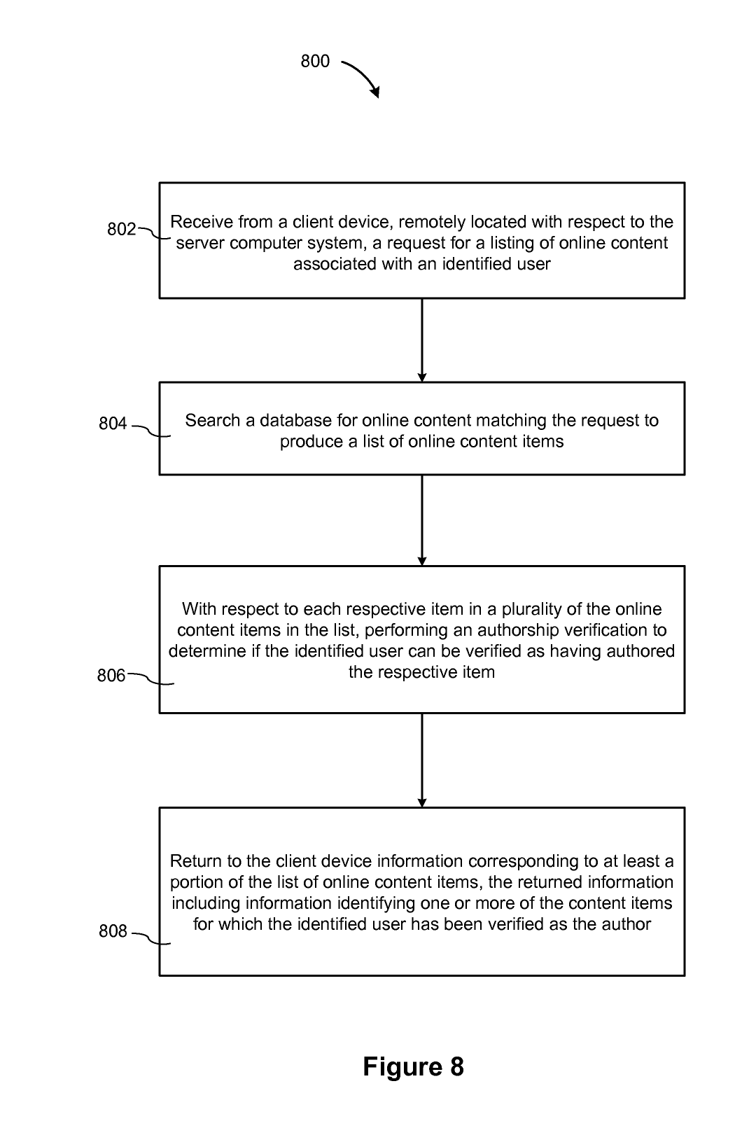

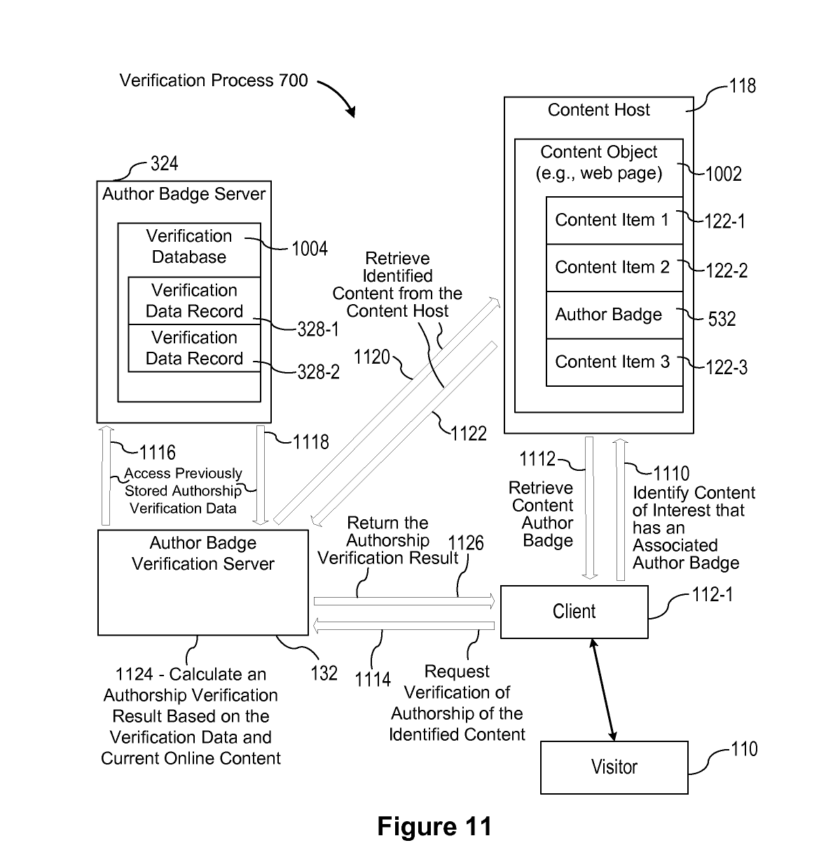

FIG. 3 is a block diagram illustrating an Author Badge Server 124 that facilitates authorship verification in accordance with some embodiments of the present invention. The Author Badge Server 124 typically includes one or more processing units (CPU's) 302 for executing modules, programs and/or instructions stored in memory 314 and thereby performing processing operations; one or more network or other communications interfaces 304; memory 314; and one or more communication buses 312 for interconnecting these components. The communication buses 312 may include circuitry (sometimes called a chipset) that interconnects and controls communications between system components. In some embodiments, the Author Badge Server 124 includes a user interface 306 comprising a display device 308 and one or more input devices 310. In some embodiments, memory 314 includes high-speed random access memory, such as DRAM, SRAM, DDR RAM or other random access solid state memory devices. In some embodiments, memory 314 includes non-volatile memory, such as one or more magnetic disk storage devices, optical disk storage devices, flash memory devices, or other non-volatile solid state storage devices. Optionally, memory 314 includes one or more storage devices remotely located from the CPU(s) 302. Memory 314, or alternately the non-volatile memory device(s) within memory 314, comprises a computer readable storage medium. In some embodiments, memory 314 or the computer readable storage medium of memory 314 stores the following programs, modules and data structures, or a subset thereof:
an operating system 316 that includes procedures for handling various basic system services and for performing hardware dependent tasks;
a communications module 318 that is used for connecting the Author Badge Server 124 to other computers via the one or more communication network interfaces 304 (wired or wireless) and one or more communication networks 116, such as the Internet, other wide area networks, local area networks, metropolitan area networks, and so on;
a web server 320 that receives requests from client computers, such as a request to establishing authorship of an online content item 122 or to verify authorship of an online content item 122;
a badging module 322 that creates content author badges and stores the information associated with content author badges. The badging module 322 includes a badge identifier generation process 324, which generates a badge identifier for each content author badge. In some embodiments, the badge identifier generation process creates unique badge identifiers. The badging module 322 is described in more detail below with respect to FIGS. 5A, 5B, 6A, 6B, 9, and 10;
a verification module 326 that verifies authorship of identified content items 122. To perform the verification process 700 (see FIGS. 7 and 11), the verification module uses verification information 328. In some embodiments, verification information 328 is saved in the user database, while in other embodiments the verification information is stored in a distinct database. In some embodiments, the verification module 326 is part of the author badge server 124, but in other embodiments, the verification module 326 is part of a distinct author badge verification server 132. In some embodiments where the verification module as part of a distinct author badge verification server 132, the verification information is stored in the user database as part of the author badge server. The verification module is described in more detail below with respect to FIGS. 5A, 7, and 11;
a query module 330 that retrieves online content items 122 associated with an identified author. The query module is described in more detail below with respect to FIG. 8; and
a user database 126 that stores user profiles 128 and user credentials 130. In some embodiments, the user database 126 stores additional information related to individual users. In some embodiments, the user database 126 is stored on a physically distinct computer, such as a database server.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 314 may store a subset of the modules and data structures identified above. Furthermore, memory 314 may store additional modules or data structures not described above.

Although FIG. 3 shows an Author Badge Server 124 used for creating and deploying author badges, FIG. 3 is intended more as functional description of the various features which may be present in a set of one or more computers rather than as a structural schematic of the embodiments described herein. In practice, and as recognized by those of ordinary skill in the art, items shown separately could be combined and some items could be separated. For example, some items shown separately in FIG. 3 could be implemented on individual computer systems and single items could be implemented by one or more computer systems. The actual number of computers used to implement an author badge server 124 and/or an author badge verification server 132, and how features are allocated among them will vary from one implementation to another, and may depend in part on the amount of data traffic that the system must handle during peak usage periods as well as during average usage periods.

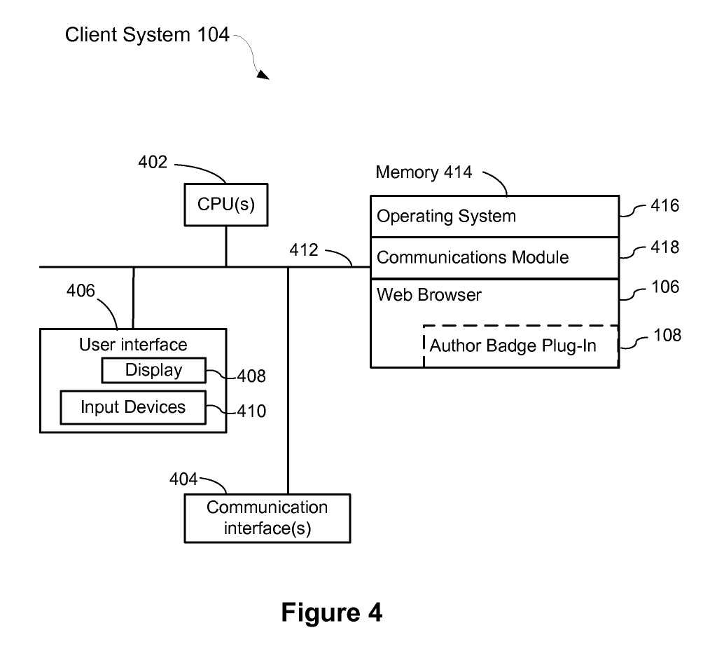

FIG. 4 is a block diagram illustrating a client computer system 104 that is used by a author 102 to create online content items 122 at a content host 118, and to establish authorship of the online content items 122 using an author badge server 124 in accordance with some embodiments of the present invention. A client computer system 104 typically includes one or more processing units (CPU's) 402 for executing modules, programs and/or instructions stored in memory 414 and thereby performing processing operations; one or more network or other communications interfaces 404; memory 414; and one or more communication buses 412 for interconnecting these components. The communication buses 412 may include circuitry (sometimes called a chipset) that interconnects and controls communications between system components. A client computer system 104 includes a user interface 406 comprising a display device 408 and one or more input devices 410. In some embodiments, memory 414 includes high-speed random access memory, such as DRAM, SRAM, DDR RAM or other random access solid state memory devices. In some embodiments, memory 414 includes non-volatile memory, such as one or more magnetic disk storage devices, optical disk storage devices, flash memory devices, or other non-volatile solid state storage devices. Optionally, memory 414 includes one or more storage devices remotely located from the CPU(s) 402. Memory 414, or alternately the non-volatile memory device(s) within memory 414, comprises a computer readable storage medium. In some embodiments, memory 414 or the computer readable storage medium of memory 414 stores the following programs, modules and data structures, or a subset thereof:
an operating system 416 that includes procedures for handling various basic system services and for performing hardware dependent tasks;
a communications module 418 that is used for connecting the client computer system 104 to other computers via the one or more communication network interfaces 404 (wired or wireless) and one or more communication networks 116, such as the Internet, other wide area networks, local area networks, metropolitan area networks, and so on; and
a web browser 106 (or other client application) that enables a user or author to communicate over a network 116 (such as the Internet) with remote computers. In some embodiments, an author badge plug-in 108 that has been added to the web browser 106 communicates with an author badge server 124. In other embodiments, an author badge client program runs in conjunction with the web browser 106, but not as an integrated part of the web browser 106.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 414 may store a subset of the modules and data structures identified above. Furthermore, memory 414 may store additional modules or data structures not described above.

Although FIG. 4 shows an client computer system 104 used by an author to create online content and affix author badges to that content, FIG. 4 is intended more as functional description of the various features which may be present in a set of one or more computers rather than as a structural schematic of the embodiments described herein. In practice, and as recognized by those of ordinary skill in the art, items shown separately could be combined and some items could be separated.

FIG. 5A illustrates an exemplary verification data structure 500 that may be used to verify authorship of an online content item 122. Verification data stored within the structure 500 may be used to verify one or more of: whether the asserted author is associated with the identified online content; whether the scope of the identified content matches the scope of what the author wrote (e.g., in a conversation thread with multiple authors, only the relevant portions are attributed to the identified author); and whether the content originally written by the author has been modified. In some embodiments, the verification process also reviews the formatting of the text, such as highlighting, underlining, bolding, and italics, to make sure the formatting has not been modified.

In some embodiments, the verification data structure 500 has a record 501 for each online content item for which an author badge has been created. In some embodiments, a respective record 501 (e.g., 501-2) of the verification data structure 500 includes a user identifier 502. The user ID 502 uniquely identifies the author of the associated online content. In some embodiments, the user ID 502 is an email address (which typically guarantees uniqueness), such as someone@gmail.com. In other embodiments the user ID 502 is a string of characters selected by the user, or a unique string of characters generated by a computer. In some embodiments, each online content item 122 for which an author badge has been created has an associated badge identifier 504. In some embodiments, each distinct online content item 122 has a unique badge identifier 504. In other embodiments, more than one badge identifier 504 may be used to badge the same online content item 122. In some embodiments, a single badge identifier 504 may be associated with multiple distinct online content items 122. For example, an author may create several content author badges, each with a different purpose, and provide a different level of information about the author for each of the badge identifiers.

In some embodiments, the verification data structure 500 includes the content location field 506, which stores the network location where the online content item 122 is posted. In some embodiments the content location is specified by a URL, such as www.OnlineBlog.org/example1/example2. In other embodiments, the content location is specified by an IP address. In some embodiments, the content location may be specified by a URL or an IP address. To address content items 122 whose locations are subject to change, some embodiments include an original content location, which may be in addition to or instead of the content location 506 above. In some embodiments where the badge identifier 504 uniquely identifies the content item, the verification data structure 500 does not include a content location field 506. In these embodiments, the content location may change; as long as the appropriate badge identifier 504 is affixed to the content item 122, the content can be verified.

A single web page or online document may include content written by more than one author, so some embodiments of the present invention address how to verify authorship of portions of a document. To verify a portion of a document, the portion must be delineated in some way. Some embodiments use the HTML <div> tag to identify a portion, such as <html> . . . <div id=5792> the portion</div> . . . </html>. In this example, the relevant portion is between <div> and </div>, and in this case the portion uses the identifier 5792. The <div> tags in this example are one way to specify content scope 508. In some embodiments, when the content scope 508 is the entire web page or document, the content scope 508 may be blank or filled with a specific character or string of characters.

In some embodiments, the verification data structure 500 includes content verification data 510. In some embodiments, the content verification data 510 comprises a hash value calculated (using a hash function) for the content. A good hash function will return a different value if the content is modified. Thus comparing HashFunction(original content) to HashFunction(current content) determines with high certainty whether the content has changed. Hash functions are sometimes called one-way functions because they are not reversible (the content cannot be recovered from the hash value). Many hash functions generate an output having a fixed length or size (e.g., 128 bits, 64 bytes, etc.), regardless of the size of the content to which the hash function is applied. Note that in general the online location of the content is not embedded in the content itself, so the hash comparison identifies whether the content has changed regardless of whether the content has moved. The hash value computed for the content is sometimes referred to herein as a Content Fingerprint.

The content fingerprint 510 may be produced by applying a one-way function, such as a hash function or CRC (cyclic redundancy check) function. In some embodiments, the content fingerprint has a fixed size, such as 128 bits, that is independent of the size of the corresponding content. In other embodiments, the content fingerprint may vary in size depending on the size of the content.

In some alternative embodiments, the content verification data 510 comprises a complete copy of the content to be verified. Although this requires more storage space than hash values, with inexpensive memory and disk space, this method becomes a simple viable option. In other embodiments, the content verification data 510 comprises a sampling of the content, or both a content fingerprint and a sampling of the content.

The verification data structure 500 includes a verification location 512. The verification location 512 is the network address where the authorship can be verified. In some embodiments the verification location 512 is specified as a URL, and in other embodiments the verification location is specified as an IP address. Some embodiments allow the verification location to be specified as either a URL or an IP address.

FIG. 5B depicts an exemplary content author badge 532 configured as an HTML tag. The content author badge 532 comprises a beginning anchor tag <a> 520 with some embedded parameters, the name of the author 528 as it will be rendered by a browser, and an ending anchor tag </a> 530. In some embodiments, the parameter rel=“author” 522 indicates that the tag is specifying the author of posted content. The href parameter specifies the location 524 where the content author badge may be verified. In some embodiments the href parameter includes the badge identifier 504 so that the author badge verification server 132 can look up the appropriate verification information. In other embodiments, the href parameter includes the content location where the online content item 122 is posted. Typically, the badge identifier 504 indirectly identifies the location of the content associated with the author badge, through a lookup operation using the verification data structure 500 (FIG. 5A). In some embodiments, when the scope of the content item 122 is less than the full web page or document, the anchor tag includes a “scope” parameter such as scope=5792.

In some embodiments, an image tag <img> is used instead of an anchor tag<a> as described above. In embodiments that use an <img> tag, the verification information is acquired while loading the current web page rather than waiting until the hyperlink is activated.

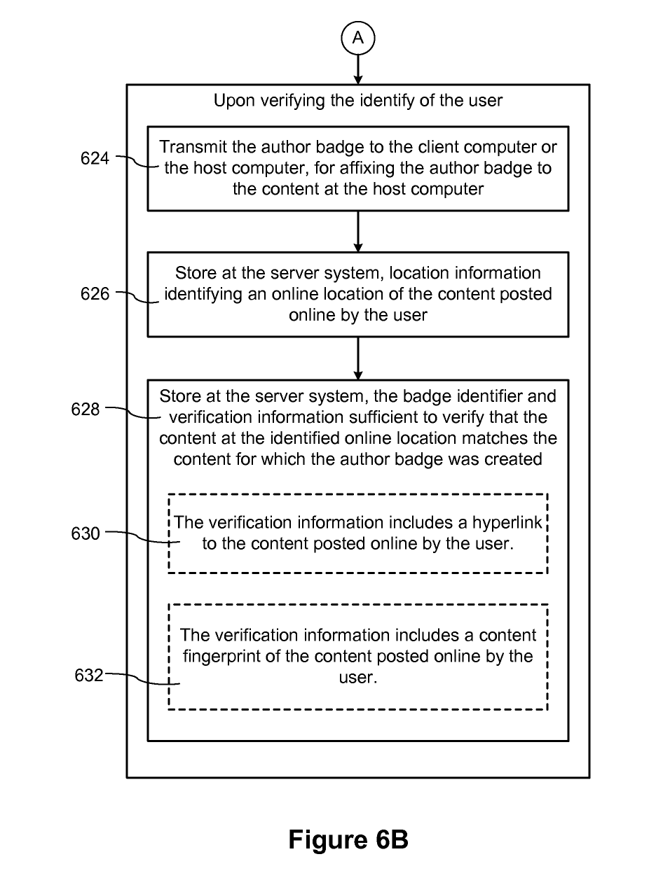

FIGS. 6A and 6B are a flowchart of an exemplary process 600 used by an author badge server 124 to badge content posted online and to record authorship information of the content posted online, according to some embodiments. Initially, the badging module 322 on the author badge server 124 receives (602) a request from a user at a client computer to establish authorship of content posted online by the user. The online content is stored on a host computer (e.g., posted by the user onto the host computer) that is distinct from the client computer and distinct from the author badge server. The user's identify is verified (604) by comparing the supplied credentials to the credentials stored at the author badge server 124. In some embodiments the credentials comprise a user id and a password.

Once the user's identify has been verified (606), the author badge server creates (608) an author badge 532 (also known as a content author badge) for the content. In some embodiments, an existing badge identifier 504 is used for the author badge. In other embodiments, a new badge identifier 504 is created as part of creating a new author badge 532. In either case, the badge identifier 504 is part of the author badge 532. In some embodiments, the badge identifier is unique (610). In some embodiments, an author badge 532 is configured as an HTML tag or as an XML tag (or both). In other embodiments, an author badge 532 includes one or more portions that are configured as HTML tags or XML tags.

In some embodiments, the author badge 532 is configured to be stored in a web page that includes the content posted online by the user (614). For example, the author badge 532 may appear at the bottom of the content, or below the title or a heading of the content, like a newspaper article byline. In other embodiments, the author badge 532 is configured to be stored within a web page associated with the content posted online by the user (612). For example, the author badge 532 may appear in a table of contents that is on a web page distinct from the web page where the online content is posted. In some embodiments, the author badge 532 may appear on the web page with the content item 122 as well as a table of contents. In some embodiments, the content posted online by the user (i.e., content item) 122 comprises an entire web page. In other embodiments, the content item 122 comprises only a portion of a web page. When the content item 122 comprises only a portion of a web page, the portion is delineated to identify the scope. In this case, a scope identifier is included in the author badge 532, for example as an HTML tag parameter.

In some embodiments, the author badge 532 includes the online location of an author badge verification server 132, which can verify authorship of the content item 122 posted online by the user (616). In some embodiments, the author badge 532 includes an HTML tag that includes both a unique badge identifier 504 and a URL or IP address of an online service for verifying authorship (e.g., and author badge verification server 132) of the content posted online 122 by the user (618). In some embodiments where the author badge 532 includes an HTML tag with both a unique badge identifier 504 and the location 524 of the author badge verification server 132, the HTML tag is configured to be rendered when the content item 122 is rendered in a client resident application (e.g., web browser) (620).

In some embodiments, the author badge 532 is configured so that additional data displays (622) when a viewer of the content item 122 hovers a pointer device over or near (i.e., in a region associated with) the author badge 532. In some embodiments, “hovering” a pointer device is recognized by having the pointer remain in the designated region for at least a predetermined amount of time. The additional data comprises information associated with the author of the content item 122, and is retrieved from an author badge verification server 132. The additional data is subsequently displayed on the client computer used by the viewer of the content item 122.

After creating the author badge 532, the author badge server 124 transmits (624) the author badge either to the originating client computer 104 or directly to the host computer 118 for affixing the author badge 532 to the content item 122 at the host computer 118. In embodiments where the author badge 532 is transmitted to the client computer 104, the client computer 104, or the author badge plug-in 108 on the client computer will subsequently affix the author badge 532 to the content item 122. In some embodiments, an author badge 532 is affixed to a content item 122 by concatenating an author badge character string to the end of the content item 532. In some embodiments, an author badge 532 is affixed to a content item 122 by saving the author badge 532 in a table of contents or other web page associated with the content item 122 so that a viewer of the web page will visually see the association between the content item 122 and the author badge 532. In some embodiments, an author badge 532 is affixed to a content item 122 using JavaScript®, an HTML <img> tag, or other code so that authorship verification automatically occurs when a viewer opens the content item 122. An author badge 532 may be affixed to a content item 122 using any means that visually or programmatically associates the author badge 532 with the content item 122. Typically, storage of the affixed author badge 532 and the content item 122 are managed by the same host computer 118.

The author badge server 124 typically stores (626) location information that identifies the online location of the content item 122 posted online by the user. In some embodiments where the location of content items 122 is subject to change, the author badge server 124 stores the original location of the content item 122. In other embodiments where the location of content items is subject to change, the location of the host computer is not saved. Instead, the author badge server 124 stores verification information 328 sufficient to verify that the content at the identified online location matches the content for which the author badge was created (or to which the author badge was originally affixed) (628), even though the content's location may have changed since it was posted. Optionally, the verification information includes a hyperlink to the content item 122 posted online by the user (630). In some embodiments, the verification information includes a content fingerprint of the content item 122 posted online by the user (632). In some embodiments, a content fingerprint comprises a hash value computed from the content, such as ContentFingerprintHashFunction(content).

FIG. 7 is a flowchart of an exemplary process 700 to verify authorship of a content item 122 posted online. Initially, the author badge verification server 132 receives (702) a request from a client device 112-1 to verify a claim of authorship of content posted online 122 at a hosting computer system 118. The client device 112-1 is remotely located with respect to the author badge verification server 132. The request includes information identifying an online location of the content item 122 for which the claim of authorship is to be verified. Alternately, the request includes a copy of the content for which the claim of authorship is to be verified. Typically, the request includes (704) a badge identifier 504 that uniquely identifies the content item 122.

The verification process 700 accesses (706) previously stored authorship verification information 328, if any, corresponding to the online location identified by the request. In some embodiments, the previously stored authorship verification information 328 comprises (708) a content fingerprint of content previously posted at the online location identified by the request. Alternately, or in addition, the previously stored authorship verification information 328 comprises the entire content previously posted at the online location identified by the request, or portions thereof (such as a sampling).

The verification process 700 compares (710) the current content at the identified online location with the previously stored authorship verification information 328, if any, to produce an authorship verification result. In some embodiments, the verification result just identifies whether there is an exact match between the previous content and the current content. In other embodiments, the verification result provides more detailed information about the differences, if any. In some embodiments, the verification result further incorporates (712) a determination of whether the badge identifier provided in the request is associated with content at the identified online location. The verification process returns (714) the authorship verification result to the client device 122-1.

FIG. 8 is a flowchart of an exemplary query process 800 for finding online content items 122 by an identified author 102. A server computer system receives (802) a request from a client device 112-1 for a listing of online content items 122 associated with an identified user (author) 102. The client device 112-1 is remotely located with respect to the server computer system. The query process 800 searches (804) a database for online content matching the request, thus producing a list of online content items 122.

For a plurality of content items 122 in the list, the query process 800 performs (806) an authorship verification (e.g., as described in verification process 700) to determine if the identified user 102 can be verified as having authored the respective content item 122. In this context and in this document, “authored” is defined to mean “posted” or “posted online” and “verified as having authored” is defined to mean “verified as having posted.” The embodiments described here do not detect or protect against plagiarism. Rather, the embodiments detect and protect against revision of content after it has been posted by a person or entity. The query process then returns (808) to the client device 112-1 information corresponding to at least a portion of the list of online content items 122, and the returned information includes information identifying one or more of the content items 122 for which the identified user 102 has been verified as the author. In some embodiments, the returned list includes only content items 122 for which the identified user 102 has been verified as the author.

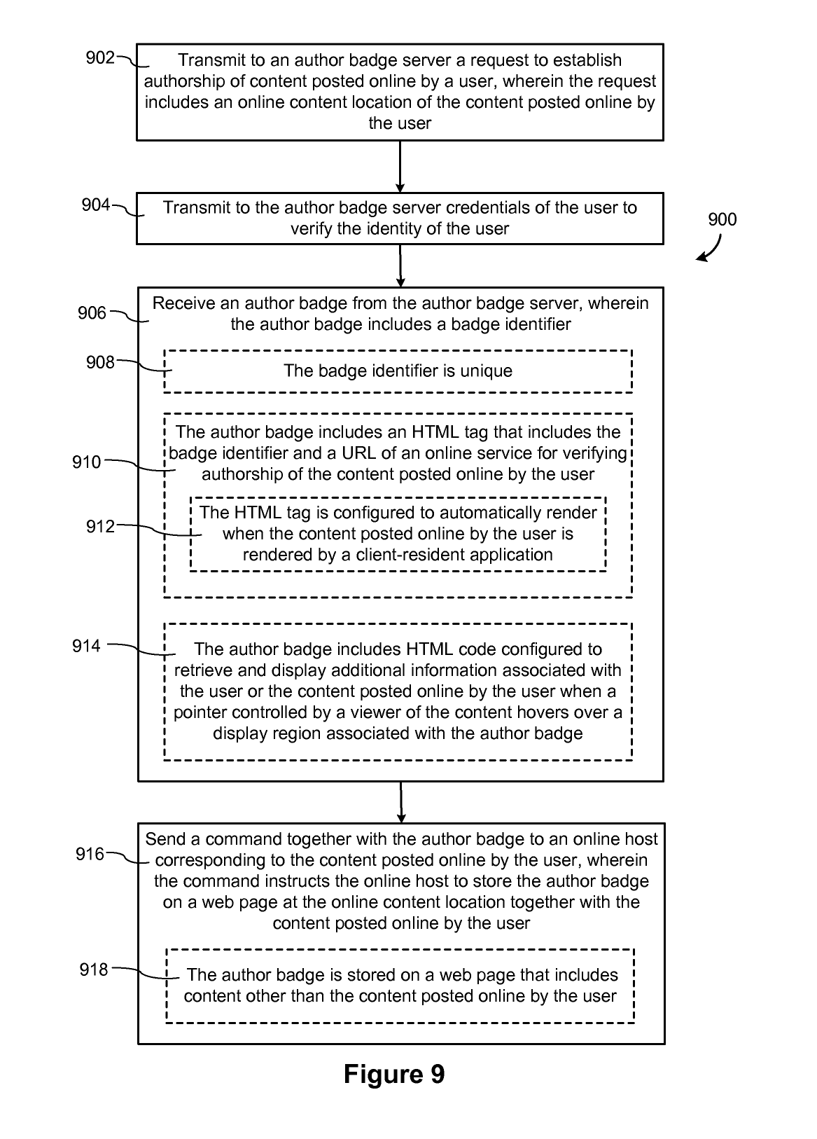

FIG. 9 is a flowchart of an exemplary badging process 900 from the perspective of the client computer 104 used by the author 102 of the online content (e.g., the person or entity that is posting the online content). The client computer 104 transmits (902) to an author badge server 124 a request to establish authorship of content posted online by the user 102. In some embodiments, the request includes an online content location of the content posted online by the user. In some embodiments, the request includes a copy of the content posted online by the user. The client computer also transmits (904) to the author badge server credentials of the user 102 to verify the identify of the user 102.

The client computer subsequently receives (906) an author badge 532 from the author badge server 124, which includes a badge identifier 504. In some embodiments, the badge identifier 504 is unique (908) to the posted online content for which the request was submitted (see 902). In some embodiments, the author badge 532 includes (910) an HTML tag that includes the badge identifier 504 and a URL of an online service for verifying authorship of the content posted online by the user. In some embodiments, the HTML tag is configured (912) to automatically render when the content posted online by the user is rendered by a web browser or other client-resident application. For example, when the content item 122 and the verification service information are in an HTML <img> tag, the verification occurs while the content is being rendered. In some embodiments, the author badge 532 includes (914) HTML code configured to retrieve and display additional information associated with the user 102 of the content item 122 posted online by the user when a pointer controlled by a viewer 110 of the content item 122 hovers over a display region associated with the author badge 532.

The client computer 104 sends (916) a command together with the author badge 532 to the online content host 118 corresponding to the content item 122 posted online by the user, and the command instructs the online content host 118 to store the author badge 532 on a web page at the online content location together with the content item 122 posted online by the user 102. In some embodiments, the author badge 532 is stored (918) on a web page that includes content other than the content item 122 posted online by the user 102. In some embodiments, the author badge 532 is stored on a web page that includes only the content item 122 posted online by the user 102.

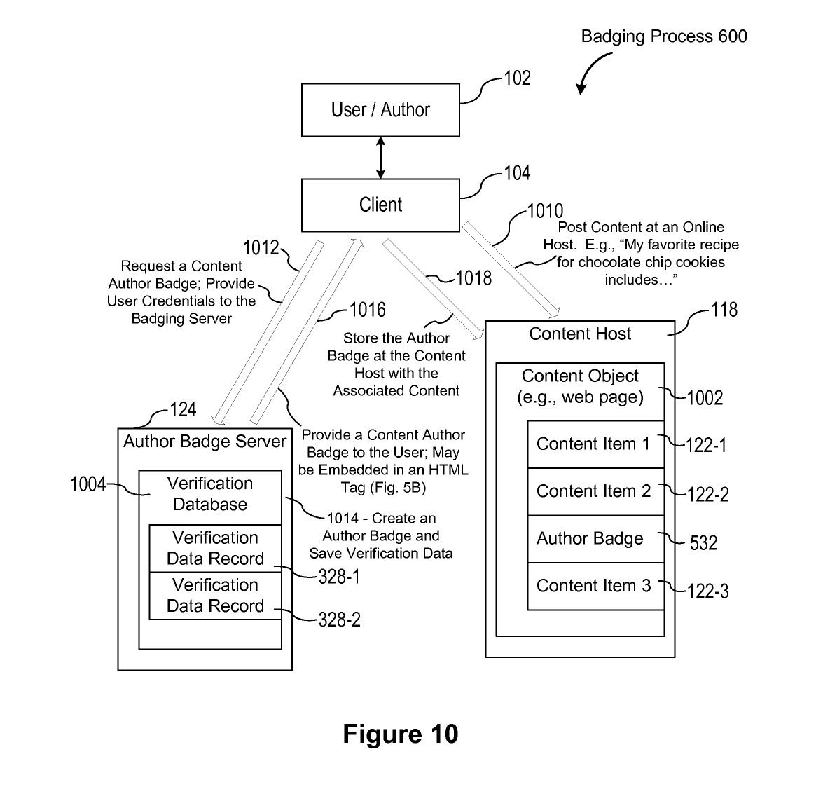

FIG. 10 schematically depicts an exemplary badging process 600. The reader may compare the badging process 600 shown in FIG. 10 with the verification process 700 shown in FIG. 11.

The user 102 at client computer 104 begins by posting (1010) content at an online host 118. The content host 118 has one or more content objects 1002, which in some embodiments are web pages. The content object 1002 stores one or more content items 122-1, 122-2, 122-3, etc. In the example shown in FIG. 10, the user 102 has saved content item 2 (122-2) on the content host 118. After saving the content item 122-2, the user 102 at client computer 104 requests (1012) a content author badge 532 from an author badge server 124. Either with the request, or thereafter, the user 102 provides credentials so that the author badge server 124 can verify the identity of the user 102. The author badge server 124 creates (1014) an author badge and saves verification data (e.g., in a verification data record 328) so that the authorship can be verified later. In some embodiments, a verification database 1004 resides on the author badge server 124. In other embodiments, the verification database 1004 may reside at an author badge verification server 132, or other remote database server. The verification database 1004 contains one or more verification data records 328-1, 328-2, etc. that store the verification data generated by the author badge server in response to requests for content author badges. In some embodiments, the verification database is a SQL database or other relational database. In other embodiments, the verification database comprises an organized set of files that are stored on a file server or other device containing a computer readable medium.

In the embodiment of FIG. 10, the author badge 532 is sent (1016) to the client computer 104, which the client computer 104 subsequently sends to the content host 118 to be stored (1018) at the content host 118 together with the associated content item 122-2. In alternative embodiments, the content author badge 532 is sent directly from the author badge server 124 to the content host 118 for storage with the content item 122-2.

FIG. 11 schematically depicts an exemplary verification process 700. The author 102 (and the author's computer 104) is not involved in the verification process 700.

As previously seen in FIG. 10, a content host 118 has one or more content objects 1002 (such as web pages), and each content object 1002 contains one or more content items 122-1, 122-2, 122-3, etc. Some of the content items have associated author badges 532. When the user 102 previously established authorship of content item 122-2, verification information 328-2 was stored in a verification database 1004, which may reside at an author badge server 324. The verification database contains one or more verification data records 328-1, 328-2, etc. In some embodiments, the verification database 1004 is stored at the author badge verification server 132, or on another remote database server or file server.

A visitor 110 at client computer 112-1 identifies (1110) content of interest at a content host 118, and the content item 122-2 has an associated author badge 532. The author badge 532 is retrieved (1112) from the content host 118. The client computer 112-1 requests (1114) verification of authorship of the identified content from an author badge verification server 132 identified in the content author badge 532. In the embodiment of FIG. 11, the author badge verification server 132 accesses (1116) previously stored authorship verification data 328-2 stored in the verification database 1004 at the author badge server 324. In other embodiments, the verification database is stored at an author badge verification server 132, or on a remote database server or file server. The verification data record 328-2 is returned (1118) to the author badge verification server 132. The author badge verification server also accesses (1120) the current content 122-2 at the content host 118, which is returned (1122) to the author badge verification server 132. Using methods described above with respect to FIGS. 5A and 7, the author badge verification server calculates (1124) an authorship verification result based on the previously stored verification data 328-2 and the current content 122-2 at the content host 118. The author badge verification server 132 then returns (1126) the authorship verification result to the client computer 112-1 for viewing by the visitor 110.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at a server system with one or more processors and memory storing one or more programs for execution by the one or more processors, the one or more programs including instructions for:
receiving a request from a user at a client computer to establish authorship of content posted online by the user, wherein the content is stored at a host computer;
verifying identity of the user by verifying credentials of the user; and
upon verifying the identity of the user,
creating an author badge for the content posted online by the user, wherein the author badge includes a badge identifier;
transmitting the author badge to the client computer or the host computer, for affixing the author badge to the content at the host computer;
storing at the server system, location information identifying an online location of the content posted online by the user; and
storing at the server system, the badge identifier and verification information sufficient to verify that the content at the identified online location matches the content for which the author badge was created.

2. The method of claim 1, wherein the badge identifier is unique.

3. The method of claim 1, wherein the author badge is configured to be stored within a web page associated with the content posted online by the user.

4. The method of claim 1, wherein the author badge is configured to be stored in a web page that includes the content posted online by the user.

5. The method of claim 1, wherein the author badge includes an online location of an online service for verifying authorship of the content posted online by the user.

6. The method of claim 1, wherein the verification information includes a hyperlink to the content posted online by the user.

7. The method of claim 1, wherein the verification information includes a content fingerprint of the content posted online by the user.

8. The method of claim 1, wherein the author badge includes an HTML tag that includes the badge identifier and a URL of an online service for verifying authorship of the content posted online by the user.

9. The method of claim 8, wherein the HTML tag is configured to be automatically rendered when the content posted online by the user is rendered by a client-resident application.

10. The method of claim 1, wherein the user is an author of the content and the author badge is configured so that, when a pointer controlled by a viewer of the content hovers over a display region associated with the author badge, a client computer associated with the viewer retrieves and displays additional information associated with the author of the content or the content posted online by the author.

11. A server system, comprising:
one or more processors;
memory; and
one or more programs stored in the memory for execution by the one or more processors, the one or more programs comprising instructions for:
receiving a request from a user at a client computer to establish authorship of content posted online by the user, wherein the content is stored at a host computer;
verifying identity of the user by verifying credentials of the user; and
upon verifying the identity of the user,
creating an author badge for the content posted online by the user, wherein the author badge includes a badge identifier;
transmitting the author badge to the client computer or the host computer, for affixing the author badge to the content at the host computer;
storing at the server system, location information identifying an online location of the content posted online by the user; and
storing at the server system, the badge identifier and verification information sufficient to verify that the content at the identified online location matches the content for which the author badge was created.

12. A computer readable storage medium storing one or more programs configured for execution by a server computer system having one or more processors and memory storing one or more programs for execution by the one or more processors, the one or more programs comprising instructions to:
receiving a request from a user at a client computer to establish authorship of content posted online by the user, wherein the content is stored at a host computer;
verifying identity of the user by verifying credentials of the user; and
upon verifying the identity of the user,
creating an author badge for the content posted online by the user, wherein the author badge includes a badge identifier;
transmitting the author badge to the client computer or the host computer, for affixing the author badge to the content at the host computer;
storing at the server system, location information identifying an online location of the content posted online by the user; and
storing at the server system, the badge identifier and verification information sufficient to verify that the content at the identified online location matches the content for which the author badge was created.

13. A method, comprising:
at a server computer system with one or more processors and memory storing one or more programs for execution by the one or more processors, the one or more programs including instructions for:
receiving from a client device, remotely located with respect to the server computer system, a request to verify a claim of authorship of content posted online at a hosting computer system that is distinct from the server computer system, the request including information identifying an online location of the content for which the claim of authorship is to be verified;
accessing previously stored authorship verification information, if any, corresponding to the online location identified by the request;
comparing the content at the identified online location with the previously stored authorship verification information, if any, to produce an authorship verification result; and
returning the authorship verification result to the client device.

14. The method of claim 13, wherein the previously stored authorship verification information comprises a content fingerprint of content previously posted at the online location identified by the request.

15. The method of claim 13, wherein the request further includes a badge identifier, and the authorship verification result further incorporates a determination of whether the badge identifier is associated with content at the identified online location.

16. A server computer system, comprising:
one or more processors;
memory; and
one or more programs stored in the memory for execution by the one or more processors, the one or more programs comprising instructions for:
receiving from a client device, remotely located with respect to the server computer system, a request to verify a claim of authorship of content posted online at a hosting computer system that is distinct from the server computer system, the request including information identifying an online location of the content for which the claim of authorship is to be verified;
accessing previously stored authorship verification information, if any, corresponding to the online location identified by the request;
comparing the content at the identified online location with the previously stored authorship verification information, if any, to produce an authorship verification result; and
returning the authorship verification result to the client device.

17. A computer readable storage medium storing one or more programs configured for execution by a server computer system having one or more processors and memory storing one or more programs for execution by the one or more processors, the one or more programs comprising instructions to:
receiving from a client device, remotely located with respect to the server computer system, a request to verify a claim of authorship of content posted online at a hosting computer system that is distinct from the server computer system, the request including information identifying an online location of the content for which the claim of authorship is to be verified;
accessing previously stored authorship verification information, if any, corresponding to the online location identified by the request;
comparing the content at the identified online location with the previously stored authorship verification information, if any, to produce an authorship verification result; and
returning the authorship verification result to the client device.
